(19) United States
(12) Patent Application Publication
(10) Pub. No.: US 2014/0206397 A1
(43) Pub. Date: Jul. 24, 2014

(54) MOBILE NOTIFICATION SYSTEM

(71) Applicant: Yahoo! Inc., Sunnyvale, CA (US)

(72) Inventors: David Anthony Burgess, Menlo Park, CA (US); James William DelliSanti, Los Altos, CA (US); Devesh Patel, Cupertino, CA (US); Soren Riise, Cupertino, CA (US)

(73) Assignee: Yahoo! Inc., Sunnyvale, CA (US)

(21) Appl. No.: 14/165,402

(22) Filed: Jan. 27, 2014

Related U.S. Application Data
(63) Continuation of application No. 11/777,084, filed on Jul. 12, 2007, now abandoned.

(51) Int. Cl. H04W 4/02

(52) U.S. Cl. CPC H04W 4/028; H04W 4/023
USPC 455/456.3

(57) ABSTRACT

A method for providing information to a traveler during a vehicle trip is provided, which comprises the following: monitoring a current location of a vehicle and at least one aspect of the vehicle trip other than the current location of the vehicle; and providing information to the traveler in response to as least one status change with respect to the at least one aspect of the vehicle trip based on the current location of the vehicle.

### RELATED APPLICATIONS

This application is a continuation under 35 USC §120 of prior U.S. patent application Ser. No. 11/777,084 (Attorney Docket No. YAH1P091/Y02368US00), entitled “A Mobile Notification System,” by Burgess et al, filed on Jul. 12, 2007, which is incorporated herein in its entirety and for all purposes.

### BACKGROUND OF THE INVENTION

1. Field of the Invention

The present invention relates to systems and methods for providing travel-related information to traveler(s) during a road trip in response to changes in status of various aspects of the trip.

2. Background of the Invention

During road trips and especially during long road trips to relatively unfamiliar places, it often would be helpful to receive travel-related information specifically tailored or in response to the present conditions of the trips, such as vehicle conditions, road and weather conditions, traveler conditions, time of travel (e.g., time of day or day of week), etc.

For example, if the vehicle is low on gasoline or has a mechanical problem, it may be helpful to know the locations of the nearby gas stations or repair shops. If there is a traffic jam, construction site, or accident on the road currently traveled, it may be helpful to find an alternative route. Or, if the travelers are hungry or tired, it may be helpful to know about the upcoming restaurants or rest stops. The information would be particularly helpful if it specifically addresses the problems or needs of the travelers as those problems or needs arise.

Accordingly, what are needed are systems and methods to address the above-identified problems.

### SUMMARY OF THE INVENTION

Broadly speaking, the present invention relates to systems and methods for providing travel-related information to traveler(s) during a road trip in response to changes in status of various aspects of the trip.

In one embodiment, a method for providing information to a traveler during a vehicle trip is provided, which comprises the following: monitoring a current location of a vehicle and at least one aspect of the vehicle trip other than the current location of the vehicle; and providing information to the traveler in response to as least one status change with respect to the at least one aspect of the vehicle trip based on the current location of the vehicle.

In another embodiment, a mobile system for providing information to a traveler during a vehicle trip is provided. The system comprises a plurality of electronic components configured to: monitor a current location of a vehicle and at least one aspect of the vehicle trip other than the current location of the vehicle; and provide information to the traveler in response to as least one status change with respect to the at least one aspect of the vehicle trip based on the current location of the vehicle.

In another embodiment, a computer program product for providing information to a traveler during a vehicle trip is provided. The computer program product comprises a computer-readable medium having a plurality of computer program instructions stored therein. The plurality of computer program instructions are operable to cause at least one electronic device to: monitor a current location of a vehicle and at least one aspect of the vehicle trip other than the current location of the vehicle; and provide information to the traveler in response to as least one status change with respect to the at least one aspect of the vehicle trip based on the current location of the vehicle.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a simplified diagram of an environment in which specific embodiments of the invention may be implemented.

FIG. 2 is a simplified diagram of a mobile device in accordance with one or more embodiments of the invention.

FIG. 3 is a flowchart of a method by which a mobile device monitors travel-related information and conditions during a road trip by vehicle and provides information to travelers in response to the travel-related information and conditions.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

During road trips by vehicles, it is often helpful to receive travel-related information specifically tailored or in response to the present conditions of the trips, including, for example, vehicle conditions, road and weather conditions, travel conditions (e.g., time of travel), traveler conditions, etc. In one or more embodiments, a mobile device may be utilized to continuously monitor the vehicle trip conditions and provide information in response to changes in status of the monitored conditions.

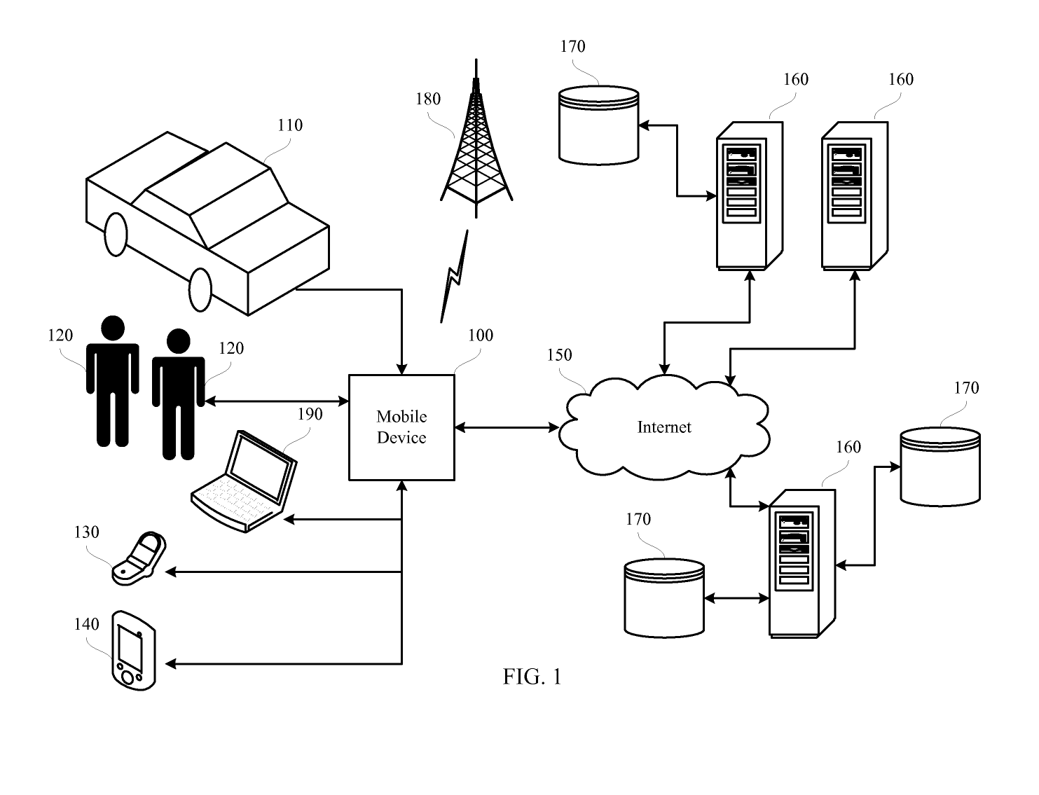

FIG. 1 is a simplified diagram of an environment in which specific embodiments of the present invention may be implemented. The mobile device 100 may include one or more electronic components, such as processor(s), RAM (random access memory), memory storage (e.g., disk drive(s) and/or flash memory), wired and/or wireless port(s) (e.g., Ethernet, Modem, USB, Firewire, or Bluetooth), input/output devices (e.g., key pad), display devices (e.g., screen), voice synthesizer and other electronic components. One or more software programs implementing the functionalities of the device may be executed on the device.

Prior to a vehicle trip, information relating to the trip and/or information relating to the personal preferences of the traveler(s) may be input into the mobile device 100 by the traveler(s) 120 to create a profile for the trip and/or the traveler(s). The traveler(s) may use the device's 100 input device, such as a key pad, to enter the trip information, or the device 100 may be connected to a computer 190 and the trip information may be downloaded to the device 100 through the computer 190.

As part of the trip and/or traveler profile setup, the mobile device 100 may be connected to the Internet 150 either by wired (e.g., via Ethernet or dial-up Modem) or by wireless connection. Optionally, certain information related to the trip and/or the traveler(s) may be downloaded from various databases 170 linked to network servers 160 via the Internet 150 and stored in memory storage on the device 100. For example, once the traveler(s) 120 have entered the travel route and/or the trip's origin and destination, relevant road maps may be downloaded from appropriate databases 170 connected to the Internet 150. In addition, information about facilities and amenities, such as restaurants, hotels, gas stations, tourist attractions, etc., along the route may also be downloaded and stored.

However, it is not always necessary to download and store such information before the trip begins. The mobile device 100 may access the Internet 150 to retrieve various pieces of information only when the information is needed (e.g., during the vehicle trip). In other words, whether or not to download and store information before the trip begins and/or the type and amount of information to be downloaded and stored on the mobile device 100 may depend on the capabilities and functionalities of the device 100 and/or traveler preferences.

Also as part of the trip and/or traveler profile setup, the traveler(s) 120 may have the option of specifying notification preferences, which indicate what type of information the traveler(s) desire to receive during the vehicle trip. For example, some traveler(s) may be only interested in road conditions and travel routes, while other traveler(s) may be interested in additional information such as tourist attractions, scenic view stops, etc. Some traveler(s) may have special health concerns that require periodical rest stops and/or special food(s) and/or drink(s). The traveler(s) 120 may specify the particular types of information to be notified during the trip based on their individual preferences and/or needs.

Optionally, the mobile device 100 may be programmed to provide a standard or default set of notifications, so that if the traveler(s) 120 choose not to customize the types of information to be received during the trip, the device 100 will provide the default set of notifications. And even if the traveler(s) 120 chooses to customize the notifications, the default notifications may still be provided in addition to the customized notifications, if the traveler(s) 120 so desire.

The mobile device 100 is also communicatively connected to the vehicle 110 so that the device 100 may monitor the conditions or status of the vehicle 110 during the trip. The connection may be direct (e.g., the device 100 is plugged into the vehicle 110 via some type of communication port). Alternative, the connection may be wireless, where the device 100 receives transmissions from the vehicle's 110 onboard computer. The mobile device 100 may also be installed in the vehicle 110, perhaps as an integral component of the vehicle 110.

Optionally, the mobile device 100 may be communicatively connected to the traveler(s)' mobile telephone 130 and/or PDA (personal digital assistant) 140 so that the device 100 may obtain information from or send messages to these devices.

During the vehicle trip, the mobile device 100 may receive radio transmissions from nearby broadcasting towers 180 and/or from satellites to obtain updated information on traffic or weather conditions, etc. Similarly, during the trip, the mobile device 100 may also access the Internet 150 if possible to retrieve trip-related information and/or information relating to the personal preferences of the traveler(s) when necessary.

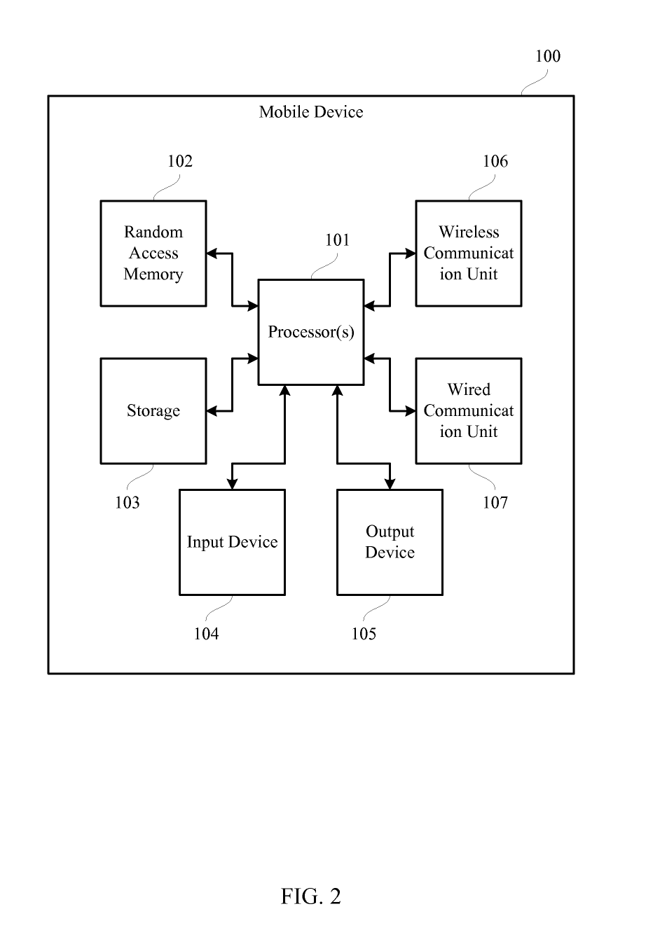

There are different ways to implement the mobile device 100. FIG. 2 is a simplified diagram of a mobile device in accordance with one or more embodiments of the invention. In this example, the mobile device 100 includes various components. First, there are one or more processors 101 that may be programmed to execute the software programs implementing various functionalities of the device 100. The processor(s) 101 may be connected with random access memory (RAM) 102 and storage 103. The RAM may be used during the execution of the software programs. The storage 103 (e.g., disk storage, flash memory, etc.) may be used to store trip and/or traveler related data downloaded from various databases via the Internet.

An input device 104, such as a key pad or a touch screen with a stylus, may be provided so that traveler(s) may enter information. An output device 105, such as a display screen or a voice synthesizer coupled with one or more speakers may be used to relay information to the traveler(s). The mobile device 100 may have both wireless communication unit(s) 105 and wired communication unit(s) for retrieving data from the Internet or receiving data from the vehicle.

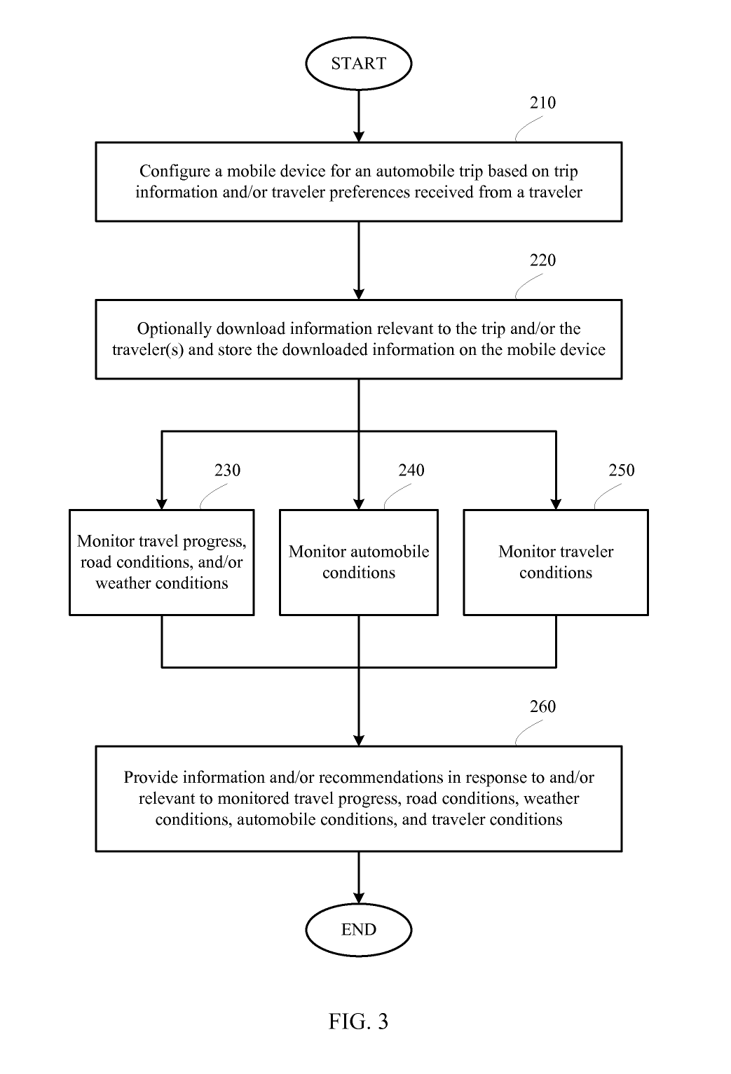

FIG. 3 is a flowchart of a method by which a mobile device monitors travel-related information and conditions during a road trip by vehicle and provides information to travelers in response to the travel-related information and conditions. This method may be carried out, for example, in an environment shown in FIG. 1.

At 210, the mobile device is configured based on trip information and/or traveler preferences received from a traveler, perhaps before the trip beings. A profile may be created based on the trip and/or traveler related information. The trip-related information may include, for example, the trip's origin, the trip's destination, the date and/or time of travel, weather and road conditions, amenities along the route, etc. The device may plot one or more possible routes based on various criteria, such as shortest distance, shortest time (possibly taking into consideration factors such as traffic conditions at various time and day), most use of freeway, etc. The traveler may then pick a particular route based on his or her personal preference, and the chosen route may be stored in memory on the device. Certain existing technologies, such as a Global Positioning System (GPS), may be utilized to help determine the possible routes for the trip.

The traveler-related information may include, for example, traveler's personal preferences. The traveler may enter information he or she is interested in along the route. For example, the traveler may be interested in nearby tourist attractions or shopping and entertainment areas along the route. The traveler may have special preferences or needs for foods and drinks The traveler may also specify notification preferences that indicate what types of information the traveler wishes to receive during the trip.

The profile may optionally be saved so that information, especially information relating to traveler preferences, may be reused for future trips.

Based on the route chosen, at 220, optionally, the relevant information may be downloaded from various databases via the Internet and/or stored on the mobile device. The relevant information may include facilities and amenities along the route, average traffic conditions for weekdays and weekends, road conditions and speed limits, and those categories of information the traveler is interested in, etc. However, it is not necessary to always download and/or store the relevant information. As explained before, the necessary information may be retrieved at the time the information is actually needed (e.g., during the vehicle trip).

During the trip, various travel-related information and conditions are continuously monitored. At 230, travel progress, road conditions, and/or weather conditions are monitored continuously. In one or more embodiments, the mobile device keeps track of the present location of the vehicle at any given time. The global positioning system (GPS) may be used to determine the present location of the vehicle at any given time. Alternatively, signals from the traveler's mobile telephone may be used to triangulate and determine the present location of the vehicle at any given time.

Radio signals sent from broadcasting towers along the route or satellite may be used to determine update road and weather conditions. Alternatively, current road and weather conditions may be obtained from various databases via the Internet. Other types of devices, such as road cameras, weather monitoring devices, may also be used to obtain various types of information relevant to the trip and/or the traveler(s).

At 240, the vehicle conditions are monitored continuously. The conditions may include gasoline, coolant, oil level, tire pressure, vehicle speed and mileage, etc.

At 250, the traveler(s)' conditions are monitored continuously. The conditions may include the last time the traveler(s) have taken a rest stop, have eaten, the travelers' and especially the driver's blood pressure, blood sugar level, brain activities, etc. If the traveler has specified any personal needs when inputting information for creating the profile for the trip, these needs may also be monitored. For example, if the traveler requires regular periodic rest stops, the time of each stop may be tracked and recorded so that the mobile device may determine the appropriate time for the next rest stop and reminds the traveler accordingly. Similarly, by tracking and recording each meal taken by the traveler, the mobile device may remind the traveler at regular intervals for meal breaks (e.g., every four or five hours).

At 260, information and/or recommendations in response to and/or relevant to travel progress, road conditions, weather conditions, vehicle conditions, and traveler conditions are provided. For example, based on the current location of the vehicle, the device may recommend nearby tourist attractions if the traveler has specified to receive that type of information. If a mechanical problem is detected, the device may provide a list of repair shops in the vicinity for the traveler to choose from. In addition to the address, telephone number, and business hours of the shops, the device may also provide ratings and/or reviews of the shops so that the traveler may make an informed choice. If the vehicle is low on gasoline, the device may provide a list of gas stations in the vicinity. Again, in addition to the locations of the gas stations, the device may also provide information such as the brand of gas supplied at each gas station and/or the price(s) for each grade of gas to help the traveler choose the desirable station.

If it is close to a meal time (breakfast, lunch, dinner), the device may provide a list of upcoming restaurants along the route, taking into consideration the travel direction of the trip. For example, if the vehicle is traveling along a particular road in a particular direction, the mobile device may select restaurant several kilometers or miles down the road in the direction of traveling. Information provided for each restaurant may include its address, telephone number, menu, etc. The traveler may call one of the restaurants some time down the road to make a reservation or put in an order so that a table or the food will be ready when the traveler arrives at the restaurant.

For safety reasons, a long-distance driver should take periodical rest stops. The device may monitor the amount of time the vehicle has traveled since the last rest stop and recommend rest stops at appropriate time intervals (e.g., every hour). If a traveler experiences health problems, the device may provide information on medical facilities in the vicinity of the present location of the vehicle, such as address, telephone number, map, etc. For example, the device may monitor the driver's blood pressure, and if there is an indication that the driver may experience high blood pressure, the device may warn the driver to stop and rest, take appropriate medications, or seek medical attention.

The device may display the appropriate messages on its own screen, or send the messages to the travelers' mobile telephone or PDA. Voice instructions may also be used to communicate with the travelers.

The monitoring of steps 230, 240, and 250 generally continues throughout the entire trip, and information may be provided in response to the monitored conditions whenever appropriate (step 260). Of course, the traveler generally has control of the mobile device and may stop the monitoring at any time if the traveler so chooses. In addition, profile for the trip may be modified or updated (step 210) if the traveler so desire. For example, the traveler may enter new preferences as the trip progresses and the new preferences may be incorporated into the existing profile. Optionally, new information may be downloaded and/or stored (step 220). Thus, steps 210, 220, 230, 240, 250, and 260 may be repeated one or more times throughout the trip as needed or desired by the traveler.

Various functionalities, such as monitoring various aspects of the vehicle trip and the current location of the vehicle and determining the relevant information to be provided to the traveler, may be implemented as software programs. These software programs may be executed on the mobile device (e.g., FIG. 1, item 100). Alternatively, some or a majority of the software programs may be executed on one or more servers (e.g., FIG. 1, item 160) connected to the Internet and the mobile device may retrieve the appropriate results from the servers when needed. In this case, the mobile device may act as a client, while some or a majority of the functionalities are executed on the server.

The system and method described above have several advantages. Most importantly, the information provided to the traveler is specifically tailored to the traveler's preferences and in response to status changes in one or more aspects of the trip being continuously monitored by the mobile device, so that the traveler generally is not overwhelmed with a great amount of information, but only receives those types of information particularly useful or helpful with respect to the present condition and location of the trip. In other words, the large amount of available information is filtered through and an intelligent decision is made as to what specific pieces of information to be provided to the traveler.

As described above, the traveler has the option of creating a trip profile and specifying his or her notification preferences. The system takes these traveler preferences into consideration when determining what specific pieces of information to provide to the traveler in addition to the status changes of various aspects of the trip and the current location of the vehicle and the traveler. For example, the traveler may specify specific types of food (e.g., Italian or Mexican food) he or she prefers, and the system may only choose restaurants serving those types of food when making restaurant recommendations to the traveler at meal times. Similarly, the system may only recommend restaurants that serve breakfast at breakfast time, and so on.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A method, comprising:
downloading information that is pertinent to at least one of a traveler or a vehicle trip;
during the vehicle trip, monitoring a current location of a vehicle and at least one aspect of the vehicle trip other than the current location of the vehicle; and
during the vehicle trip, providing information to the traveler in response to as least one status change with respect to the at least one aspect of the vehicle trip based on the current location of the vehicle, wherein the at least one aspect of the vehicle trip includes at least one of the traveler, time of day, date, day of week, road conditions, weather conditions, or travel progress;
wherein the information that is provided is based, at least in part, upon the downloaded information.

22. The method of claim 21, wherein the downloading is performed during the vehicle trip.

23. The method of claim 21, wherein the downloading is performed prior to the vehicle trip.

24. The method of claim 21, wherein the at least one aspect of the vehicle trip comprises the traveler.

25. The method of claim 24, wherein the at least one status change comprises an indication of a health problem of the traveler, an indication of a desire of the traveler for rest, or an indication of hunger of the traveler.

26. The method of claim 24, wherein the information pertains to at least one medical facility in a vicinity of the current location of the vehicle

27. The method of claim 21, further comprising:
constructing a trip profile including notification preferences indicating at least one type of information the traveler of the vehicle wishes to receive during the vehicle trip, wherein the downloading, monitoring, and providing information are performed based, at least in part, upon the trip profile.

28. The method of claim 27, wherein the notification preferences pertain to health concerns of the traveler and wherein providing the information comprises:
providing information regarding facilities or amenities pertaining to the health of the traveler that are in a vicinity of the current location of the vehicle or at a specified driving time or distance from the current location of the vehicle.

29. The method of claim 21, wherein the downloading, monitoring, and providing information are performed by a mobile device.

30. The method of claim 21, wherein monitoring comprises obtaining information pertaining to a present condition of the health of the traveler, monitoring alertness of the traveler by tracking rest stops, or monitoring hunger of the traveler by tracking meal stops.

31. An apparatus comprising a plurality of electronic components configured to perform operations, comprising:
download information that is pertinent to at least one of a traveler or a vehicle trip;
during the vehicle trip, monitor a current location of a vehicle and at least one aspect of the vehicle trip other than the current location of the vehicle; and
during the vehicle trip, provide information to the traveler in response to as least one status change with respect to the at least one aspect of the vehicle trip based on the current location of the vehicle, wherein the at least one aspect of the vehicle trip includes at least one of the traveler, time of day, date, day of week, road conditions, weather conditions, or travel progress;
wherein the information that is provided is based, at least in part, upon the downloaded information.

32. The apparatus of claim 31, wherein the downloading is performed during the vehicle trip.

33. The apparatus of claim 31, wherein the downloading is performed prior to the vehicle trip.

34. The apparatus of claim 31, the plurality of electronic components being configured to perform operations, further comprising:
construct a trip profile including notification preferences indicating at least one type of information the traveler of the vehicle wishes to receive during the vehicle trip, wherein the downloading, monitoring, and providing information are performed based, at least in part, upon the trip profile.

35. The apparatus of claim 34, wherein the notification preferences pertain to health concerns of the traveler and wherein providing the information comprises:
provide information regarding facilities or amenities pertaining to the health of the traveler that are in a vicinity of the current location of the vehicle or at a specified driving time or distance from the current location of the vehicle.

36. The apparatus of claim 31, wherein the apparatus is a mobile device.

37. At least one non-transitory computer-readable medium having a plurality of computer program instructions stored therein, which are configured to cause at least one electronic device to perform steps, comprising:
download information that is pertinent to at least one of a traveler or a vehicle trip;
during the vehicle trip, monitor a current location of a vehicle and at least one aspect of the vehicle trip other than the current location of the vehicle; and
during the vehicle trip, provide information to the traveler in response to as least one status change with respect to the at least one aspect of the vehicle trip based on the current location of the vehicle, wherein the at least one aspect of the vehicle trip includes at least one of the traveler, time of day, date, day of week, road conditions, weather conditions, or travel progress;
wherein the information that is provided is based, at least in part, upon the downloaded information.

38. The non-transitory computer-readable medium of claim 37, wherein the downloading is performed during the vehicle trip.

39. The non-transitory computer-readable medium of claim 37, wherein the downloading is performed prior to the vehicle trip.

40. The non-transitory computer-readable medium of claim 37, the plurality of computer program instructions being configured to cause at least one electronic device to perform steps, further comprising:
construct a trip profile including notification preferences indicating at least one type of information the traveler of the vehicle wishes to receive during the vehicle trip, wherein the downloading, monitoring, and providing information are performed based, at least in part, upon the trip profile.
